(19) United States
(12) Patent Application Publication
(10) Pub. No.: US 2019/0311339 A1
(43) Pub. Date: Oct. 10, 2019

(54) PAYMENT METHOD AND ELECTRONIC DEVICE USING SAME

(71) Applicant: Samsung Electronics Co., Ltd., Suwon-si, Gyeonggi-do (KR)

(72) Inventor: Van-Canh NGUYEN, Suwon-si (KR)

(21) Appl. No.: 16/339,202

(22) PCT Filed: Sep. 28, 2017
(86) PCT No.: PCT/KR2017/010865

§ 371 Date: Apr. 3, 2019

(30) Foreign Application Priority Data
Oct. 5, 2016 (KR) 10-2016-0128396

(51) Int. Cl. G06Q 20/10; G06Q 20/24; G06Q 20/32

(52) U.S. Cl. CPC G06Q 20/10; G06Q 20/3221; G06Q 20/24

(57) ABSTRACT

An electronic device for payment sharing processing, according to various examples, comprises: a communication unit for communicating with a first electronic device or a second electronic device; a database for storing at least one piece of payment information; and a processor, wherein the processor can be configured to: receive a group creation request and identification information of a user to be added to a group from the first electronic device, by using the communication unit; transmit a subscription request for the group to the second electronic device corresponding to the user identification information; determine the user corresponding to the second electronic device as a member of the group when a group subscription consent response is received from the second electronic device; receive at least one piece of payment information from the first electronic device and/or the second electronic device, and transmit integrated payment information including the received payment information to the first electronic device and the second electronic device; calculate individual payment amounts of money of respective users in the group and transmit the individual payment amounts of money to the first electronic device and the second electronic device, at least on the basis of the integrated payment information and payment consent responses when the payment consent responses are received from the first electronic device and the second electronic device; and perform a money transfer operation in which money is withdrawn from a payment service account of at least one user in the group and deposited into a payment service account of another user, when transfer consent responses based on the individual payment amounts of money are received from the first electronic device and the second electronic device. Additionally, other examples are possible.

### TECHNICAL FIELD

Various embodiments of the disclosure relate to a payment method and an electronic device and a system using the same.

### BACKGROUND ART

With the development of technology, a portable electronic device provides various services and functions, such as not only call and data transmission but also multitasking and electronic payment including mobile payment.

For example, in the case of purchasing articles or services in an online store or an offline store, a user can make a payment not only in cash but also using one of a real credit card (or cash card) and an electronic card (or application card) registered in an electronic payment service supported by a portable electronic device.

On the other hand, in order to purchase articles or services through group buying, respective individuals may pay partial amounts to a merchant, or one individual may pay the total amount to the merchant and the remaining persons may pay the partial amounts to the individual.

### DISCLOSURE OF INVENTION

### Technical Problem

In order for a plurality of users to purchase articles or services through group buying and share the payment amount, the users should directly calculate the shared amounts by individuals to cause inconvenience.

Further, in order for a plurality of users to share the purchase amount, the respective users should pay their partial amounts during purchasing in an offline store, except for cash transactions or bank account transfers between the users outside a transaction system. For example, in order for N persons to share the payment amount through electronic devices in an offline store, the merchant should perform N times payment processes.

For example, in the case where a plurality of users purchase articles from a plurality of merchants in order to prepare an event, the respective users should request the plurality of merchants to perform N times payment processes without being capable of performing individual purchasing processes, or they should perform complicated settlement processes after performing the individual purchasing processes.

### Solution to Problem

According to embodiments of the disclosure, an electronic device includes a communication module configured to communicate with an external device; a display configured to display a user interface thereon; a memory configured to store at least one piece of payment information therein; and a processor, wherein the processor is configured to transmit, to the external device, at least one of a group creation request, a request for adding a member to a group, or payment information about payment performed by a user corresponding to the electronic device, using the communication module, receive, from the external device, integrated payment information including at least one of payment information transmitted to the external device or payment information about payment performed by another user of the group, and individual payment amounts of the users of the group calculated by the external device, using the communication module, receive a result of fund transfer performed by the external device based on the individual payment amounts, and display the result of the fund transfer using the display.

According to embodiments of the disclosure, an electronic device for payment sharing processing includes a communication circuitry configured to communicate with a first electronic device or a second electronic device; a database configured to store at least one piece of payment information therein; and a processor, wherein the processor is configured to receive, from the first electronic device, a group creation request and identification information of a user to be added to a group, using the communication circuitry, transmit a subscription request for the group to the second electronic device corresponding to the user identification information, determine a user corresponding to the second electronic device as a member of the group if a group subscription consent response is received from the second electronic device, receive at least one piece of payment information from at least one of the first electronic device or the second electronic device, and transmit integrated payment information including the received payment information to the first electronic device and the second electronic device, calculate individual payment amounts of the respective users of the group and transmit the calculated individual payment amounts to the first electronic device and the second electronic device at least based on the integrated payment information and payment consent responses if the payment consent responses are received from the first electronic device and the second electronic device, and perform a fund transfer operation by withdrawing money from a payment service account of the at least one user of the group and depositing the money into a payment service account of the other user if transfer consent responses based on the individual payment amounts are received from the first electronic device and the second electronic device.

According to embodiments of the disclosure, a payment sharing method includes creating a group in accordance with a group creation request transmitted from a first electronic device and determining a plurality of users including a first user corresponding to the first electronic device as members of the group; receiving at least one piece of payment information about payment performed by at least one of the plurality of users of the group from an electronic device corresponding to the at least one of the plurality of users and transmitting integrated payment information including the received payment information to electronic devices corresponding to the respective users of the group; calculating individual payment amounts of the users of the group at least based on the integrated payment information and payment consent responses if the payment consent responses to the integrated payment information are received from the electronic devices corresponding to the respective users of the group; and performing a fund transfer operation to transfer money from at least one payment service account of the group to a payment service account of the other user based on the individual payment amounts.

### Advantageous Effects of Invention

According to the embodiments of the disclosure, a plurality of users can conveniently share the payment amount through payment using electronic devices, or can perform fund transfer between users.

In particular, it is not necessary for a plurality of users to perform payment sharing before purchasing or simultaneously with the purchasing, and it is not necessary for the plurality of users to directly calculate payment sharing amounts. Further, because it is possible to perform settlement at a time after performing a plurality of purchases from a plurality of merchants, a plurality of users can conveniently share the payment.

### BRIEF DESCRIPTION OF DRAWINGS

FIG. 1 is a diagram illustrating a network environment including electronic devices according to various embodiments of the disclosure;

FIG. 2 is a block diagram of an electronic device according to various embodiments of the disclosure;

FIG. 3 is a block diagram of a program module according to various embodiments of the disclosure;

FIG. 4A is a flowchart illustrating a payment sharing method according to various embodiments of the disclosure, and FIG. 4B is a flowchart illustrating a payment sharing method according to various embodiments of the disclosure;

FIG. 5A is a diagram illustrating a user interface for a payment sharing method according to various embodiments of the disclosure, FIG. 5B is a diagram illustrating a user interface for a payment sharing method according to various embodiments of the disclosure, FIG. 5C is a diagram illustrating a user interface for a payment sharing method according to various embodiments of the disclosure, and FIG. 5D is a diagram illustrating a user interface for a payment sharing method according to various embodiments of the disclosure;

FIG. 6A is a block diagram illustrating the configuration of a payment server according to various embodiments of the disclosure;

FIG. 6B is a block diagram illustrating the configuration of a payment service according to various embodiments of the disclosure;

FIG. 7 is a diagram illustrating a deposit transfer method through a payment service according to various embodiments of the disclosure;

FIG. 8 is a diagram illustrating a credit transfer method through a payment service according to various embodiments of the disclosure;

FIG. 9 is a diagram illustrating an offline payment performing method through a payment service according to various embodiments of the disclosure; and

FIG. 10 is a diagram illustrating an online payment performing method through a payment service according to various embodiments of the disclosure.

### MODE FOR THE INVENTION

Now, various embodiments of the present disclosure will be described with reference to the accompanying drawings. However, it should be appreciated that the present disclosure is not limited to particular embodiments and may include various modifications, equivalents, or alternatives for the following embodiments. With regard to the description of the drawings, similar reference numerals may be used to refer to similar or related elements.

In this disclosure, the terms such as “comprise”, “include”, and “have” denote the presence of stated elements, components, operations, functions, features, and the like, and do not exclude the presence of or a possibility of addition of other elements, components, operations, functions, features, and the like.

In this disclosure, the phrases such as “A or B”, “at least one of A and/or B”, or “one or more of A and/or B” may include all possible combinations of items enumerated together in a corresponding one of the phrases. For example, “A or B”, “at least one of A and B”, or “at least one of A or B” may indicate all cases of (1) including at least one A, (2) including at least one B, or (3) including both the at least one A and the at least one B.

In various embodiments, expressions including ordinal numbers, such as “1st”, “2nd”, “first”, “second,” etc., are used merely for the purpose to distinguish an element from the other elements without limiting such elements regardless of the sequence and/or importance of the elements.

When a certain element (e.g., first element) is referred to as being “connected” or “coupled” (operatively or communicatively) to another element (e.g., second element), it may mean that the first element is connected or coupled directly to the second element or indirectly through any other element (e.g., third element).

The expression “configured to” may be interchangeably used with any other expressions “suitable for”, “having the capacity to”, “designed to”, “adapted to”, “made to”, or “capable of”. The expression “configured to” may not necessarily mean “specifically designed to”. Instead, the expression “device configured to” may mean that the device, together with other devices or components, “is able to”. For example, the phrase “processor configured to perform A, B and C” may mean a dedicated processor (e.g., embedded processor) for performing corresponding operations or a generic-purpose processor (e.g., central processing unit (CPU) or application processor (AP)) capable of performing corresponding operations by executing one or more software programs stored in a memory.

The terminology used herein is for the purpose of describing particular embodiments only and is not intended to exclude other embodiments. The singular expressions may include plural expressions unless the context clearly dictates otherwise. Terms used herein, including technical or scientific terms, may have the same meaning as commonly understood by those skilled in the art. Some terms defined in a normal dictionary may be interpreted as having the same or similar meaning as the contextual meanings in the related art. Certain terms are not to be construed as an ideal or overly formal detect unless expressly defined to the contrary herein. In some cases, the terms defined herein cannot be construed to exclude embodiments of the present disclosure.

An electronic device according to various embodiments of this disclosure may include at least one of a smart phone, a tablet personal computer (PC), a mobile phone, a image phone, an e-book reader, a desktop PC, a laptop PC, a netbook computer, a workstation, a server, a personal digital assistant (PDA), a portable multimedia player (PMP), an MP3 player, a portable medical device, a digital camera, or a wearable device. According to various embodiments, the wearable device may include at least one of smart glasses, a head-mounted device (HMD), electronic cloth, an electronic bracelet, an electronic necklace, an electronic appcessory, an electronic tattoo, a smart mirror, or a smart watch.

In some embodiments, the electronic device may be home appliance. For example, the home appliance may include at least one of a TV, a digital image disk (DVD) player, audio equipment, a refrigerator, an air conditioner, a vacuum cleaner, an oven, a microwave, a washing machine, an air cleaner, a set-top box, a home automation control panel, a security control panel, a TV box (e.g., Samsung HomeSync™, Apple TV™, or Google TV™), a game console (e.g., Xbox™, PlayStation™), an electronic dictionary, an electronic key, a camcorder, or an electronic picture frame.

In another embodiment, the electronic device may include at least one of a medical device (e.g., portable medical measuring equipment (e.g., a blood sugar meter, a heart rate meter, a blood pressure meter, a clinical thermometer, etc.), a magnetic resonance angiography (MRA), a magnetic resonance imaging (MRI), a computed tomography (CT), an ultrasonography, etc.), a navigation device, a global navigation satellite system (GNSS), an event data recorder (EDR), a flight data recorder (FDR), a car infotainment device, electronic equipment for ship (e.g., a marine navigation system, a gyrocompass, etc.), avionics, security equipment, a car head unit, an industrial or home robot, an automated teller machine (ATM), a point of sales (POS), or a device for internet of things (IoT) (e.g., a bulb, a sensor, a sprinkler, a fire alarm, a thermostat, a streetlight, a toaster, athletic equipment, a hot-water tank, a heater, a boiler, etc.).

In a certain embodiment, the electronic device may be include at least one of furniture, a part of a building/construction or car, an electronic board, an electronic signature receiving device, a projector, or various measuring instruments (e.g., a water meter, an electric meter, a gas meter, a wave meter, etc.). In various embodiments, the electronic device may be one of the above-mentioned devices or a combination thereof. The electronic device according to a certain embodiment may be a flexible electronic device. The electronic device according to embodiments disclosed herein is not limited to the above-mentioned devices and may include new electronic devices to be launched with the growth of technology.

Hereinafter, an electronic device according to various embodiments will be described. In this disclosure, the term user may refer to a person or a device (e.g., an artificial intelligence device) using the electronic device.

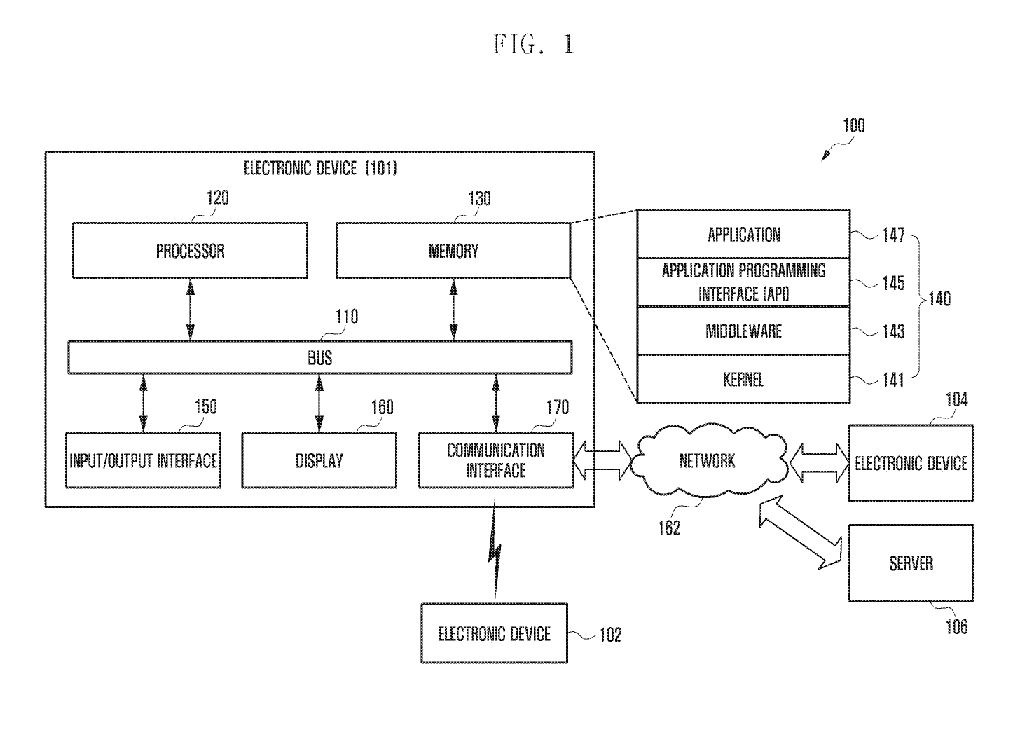

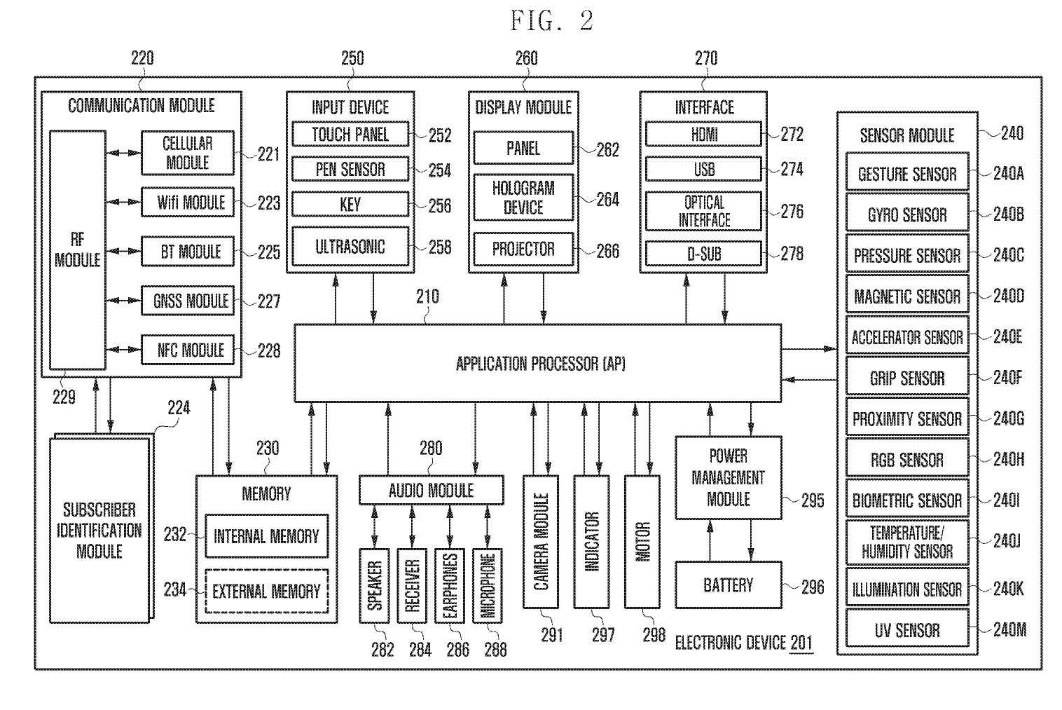

FIG. 1 is a diagram illustrating an electronic device in a network environment according to various embodiments of the present invention.

FIG. 1 shows an electronic device 101 in a network environment 100 according to various embodiments. The electronic device 100 may include a bus 110, a processor 120, a memory 130, an input/output (I/O) interface 150, a display 160, and a communication interface 170. In a certain embodiment, the electronic device 101 may omit at least one of the above elements or further include any other element.

The bus 110 may be a circuit which interconnects the above elements 120 to 170 and delivers a communication (e.g., a control message and/or data) between the above elements.

The processor 120 may include at least one of a central processing unit (CPU), an application processor (AP), or a communication processor (CP). The processor 120 may execute an operation or data processing for control and/or communication of at least one of other elements.

The programs 140 may include, for example, a kernel 141, a middleware 143, an application programming interface (API) 145, and/or an application program (or application) 147. At least some of the kernel 141, the middleware 143, and the API 145 may be referred to as an operating system (OS).

The kernel 141 may control or manage system resources (e.g., the bus 110, the processor 120, the memory 130, etc.) used to execute operations or functions implemented in other programs (e.g., the middleware 143, the API 145, and the application program 147). Also, the kernel 141 may provide an interface capable of accessing individual elements of the electronic device 101 through the middleware 143, the API 145, or the application program 147, and thereby controlling or managing system resources.

The middleware 143 may perform a function of an intermediary so that the API 145 or the application program 147 communicates with the kernel 143 and thereby exchanges data. In addition, the middleware 143 may process one or more work requests, received from the application program 147, according to priorities. For example, the middleware 143 may assign, to the application program 147, a priority for using system resources (e.g., the bus 110, the processor 120, the memory 130, etc.) of the electronic device 101 and then process the one or more work requests.

The API 145 is an interface through which the application 147 controls a function provided by the kernel 141 or the middleware 143, and may include, for example, at least one interface or function (e.g., instructions) for file control, window control, image processing, character control, and/or the like

The I/O interface 150 may transmit commands or data, inputted from a user or other external device, to other element(s) of the electronic device 101, or output commands or data, received from other element(s) of the electronic device 101, to a user or other external device.

The display 160 may include, for example, a liquid crystal display (LCD), a light-emitting diode (LED) display, an organic light-emitting diode (OLED) display, a micro-electro-mechanical systems (MEMS) display, or an electronic paper display. The display 160 may display, for example, various contents (e.g., text, image, image, icon, symbol, etc.) to a user. The display 160 may include a touch screen and may receive, for example, a touch, gesture, proximity, or hovering input using an electronic pen or a portion of the user's body.

The communication interface 170 may establish communication between the electronic device 101 and an external device (e.g., a first external electronic device 102, a second external electronic device 104, or a server 106). For example, the communication interface 170 may be connected to the network 162 via wireless or wired communication and communicate with an external device (e.g., the second external electronic device 104 or the server 106).

The wireless communication may include cellular communication using at least one of, for example, LTE, LTE Advance (LTE-A), code division multiple access (CDMA), wideband CDMA (WCDMA), universal mobile telecommunications system (UMTS), wireless broadband (WiBro), global system for mobile communications (GSM), and the like. The wired communication may include at least one of, for example, a universal serial bus (USB), a high definition multimedia interface (HDMI), a recommended standard 232 (RS-232), a power line communication, or a plain old telephone service (POTS). The network 162 may include a telecommunications network, for example, at least one of a computer network (e.g., LAN or WAN), the Internet, or a telephone network.

Each of the first and second external electronic devices 102 and 104 may be similar to or different from the electronic device 101 in types. According to an embodiment, the server 106 may include a group of one or more servers. According to various embodiments, all or part of operations performed in the electronic device 101 may be performed in another electronic device or multiple electronic devices (e.g., the electronic devices 102 and 104 and the server 106). According to an embodiment, in case of having to perform a certain function or service automatically or on demand, the electronic device 101 may request any other electronic device (e.g., the electronic device 102 or 104 or the server 106) to perform at least part of the function or service rather than or in addition to autonomously performing the function or service. Then, the other electronic device (e.g., the electronic device 102 or 104 or the server 106) may perform the requested function or service and return a result to the electronic device 101. The electronic device 101 may provide the requested function or service by using or further processing the received result. For this, cloud computing technique, distributed computing technique, or client-server computing technique may be utilized for example.

FIG. 2 is a block diagram illustrating an electronic device 201 according to embodiments. The electronic device 201 may include, for example, the whole or part of the electronic device 101 shown in FIG. 1. The electronic device 201 may include at least one application processor (AP) 210, a communication module 220, a subscriber identification module (SIM) card 224, a memory 230, a sensor module 240, an input device 250, a display 260, an interface 270, an audio module 280, a camera module 291, a power management module 295, a battery 296, an indicator 297, and a motor 298. The processor 210 may execute an operating system (OS) or an application program, control multiple hardware or software components connected to the processor 210, and perform processing and operations on various data. The processor 210 may be implemented by, for example, a system on chip (SoC). According to an embodiment, the processor 210 may further include a graphic processing unit (GPU) and/or an image signal processor. The processor 210 may include at least some of elements shown in FIG. 2 (e.g., a cellular module 221). The processor 210 may load and process instructions or data received from at least one of the other elements (e.g., non-volatile memory) into volatile memory and then store the resulting data in non-volatile memory.

The communication module 220 may be, for example, the communication module 170 shown in FIG. 1. The communication module 220 may include, for example, a cellular module 221, a Wi-Fi module 223, a Bluetooth (BT) module 225, a GNSS module 227, an NFC module 228, and a radio frequency (RF) module 229.

The cellular module 221 may provide a voice call, a image call, a messaging service, or an Internet service, for example, through a communication network. According to an embodiment, the cellular module 221 may utilize the subscriber identity module (e.g., a SIM card) 224 to perform the identification and authentication of the electronic device 201 in the communication network. According to an embodiment, the cellular module 221 may perform at least some of functions that the processor 210 may provide. According to an embodiment, the cellular module 221 may include a communications processor (CP).

Each of the WiFi module 223, the Bluetooth module 225, the GNSS module 227, and the NFC module 228 may include a processor for processing data transmitted or received therethrough. According to a certain embodiment, at least some (e.g., two or more) of the cellular module 221, the WiFi module 223, the Bluetooth module 225, the GNSS module 227, or the NFC module 228 may be included in an integrated chip (IC) or an IC package.

The RF module 229 may, for example, transmit and receive communication signals (e.g., RF signals). The RF module 229 may include, for example, a transceiver, a power amplifier module (PAM), a frequency filter, a low noise amplifier (LNA), or an antenna. According to another embodiment, at least one of the cellular module 221, the WiFi module 223, the Bluetooth module 225, the GNSS module 227, or the NFC module 228 may transmit and receive RF signals through separate RF modules.

The SIM 224 may include, for example, a card having SIM or an embedded SIM, and may include unique identification information (e.g., an integrated circuit card identifier (ICCID), or an international mobile subscriber identity (IMSI)).

The memory 230 (e.g., the memory 130 shown in FIG. 1) may include an internal memory 232 and an external memory 234. The internal memory 232 may include, for example, at least one of a volatile memory (e.g., a DRAM, an SRAM, or SDRAM), and a non-volatile memory (e.g., a one time programmable ROM (OTPROM), a PROM, an EPROM, an EEPROM, a mask ROM, a flash ROM, a flash memory, a hard drive, or a solid state drive (SSD)).

The external memory 234 may include a flash drive, for example, a compact flash (CF), a secure digital (SD), a micro-SD, a mini-SD, an extreme Digital (xD), or a memory stick. The external memory 234 may be functionally or physically connected to the electronic device 201 through various interfaces.

The sensor module 240 is capable of measuring/detecting a physical quantity or an operation state of the electronic device 201, and converting the measured or detected information into an electronic signal. The sensor module 240 is capable of including at least one of the following: a gesture sensor 240A, a gyro sensor 240B, an atmospheric pressure or barometer sensor 240C, a magnetic sensor 240D, an acceleration sensor 240E, a grip sensor 240F, a proximity sensor 240G, a color or RGB sensor 240H (e.g., a red, green and blue (RGB) sensor), a biometric sensor 2401, a temperature/humidity sensor 240J, an illuminance sensor 240K, and an ultraviolet (UV) sensor 240M. Additionally or alternatively, the sensor module 240 is capable of further including on or more of the following sensors or operations (not shown): an electronic nose (E-nose) sensor, an electromyography (EMG) sensor, an electroencephalogram (EEG) sensor, an electrocardiogram (ECG) sensor, an infrared (IR) sensor, an iris sensor and/or a fingerprint sensor. The sensor module 240 is capable of further including a control circuit for controlling one or more sensors included therein. In various embodiments of the present disclosure, the electronic device 201 is capable of including a processor, configured as part of the processor 210 or a separate component, for controlling the sensor module 240. In this case, while the processor 210 is operating in a sleep mode, the processor is capable of controlling the sensor module 240.

The input device 250 may include various input circuitry, such as, for example, and without limitation, a touch panel 252, a digital pen sensor 254, a key256, or an ultrasonic input unit 258. The touch panel 252 may recognize a touch input in a manner of capacitive type, resistive type, infrared type, or ultrasonic type. Also, the touch panel 252 may further include a control circuit. The touch panel 252 may further include a tactile layer and offer a tactile feedback to the user.

The digital pen sensor 254 may be formed in the same or similar manner as receiving a touch input or by using a separate recognition sheet. The key 256 may include, for example, a physical button, an optical key, or a keypad. The ultrasonic input unit 258 is a specific device capable of identifying data by sensing sound waves with a microphone 288 through an input tool that generates ultrasonic signals, thus allowing wireless recognition.

The display 260 (e.g., the display 160) may include a panel 262, a hologram 264, a projector 266, and/or a control circuit for controlling them. The panel 262 may have a flexible, transparent or wearable form. The panel 262 may be formed of a single module with the touch panel 252. In a certain embodiment, the panel 262 may include a pressure sensor (or a force sensor which will be interchangeably used hereinafter) capable of measuring a pressure of a user's touch. The pressure sensor may be incorporated into the touch panel 252 or formed separately from the touch panel 252. The hologram 264 may show a stereoscopic image in the air using interference of light. The projector 266 may project an image onto a screen, which may be located at the inside or outside of the electronic device 201.

The interface 270 may include various interface circuitry, such as, for example, and without limitation, an HDMI (High-Definition Multimedia Interface) 272, a USB (Universal Serial Bus) 274, an optical interface 276, or a D-sub (D-subminiature) 278. The interface 270 may be contained, for example, in the communication interface 170 shown in FIG. 1. Additionally or alternatively, the interface 270 may include, for example, an MHL (Mobile High-definition Link) interface, an SD (Secure Digital) card/MMC (Multi-Media Card) interface, or an IrDA (Infrared Data Association) interface.

The audio module 280 may perform a conversion between sounds and electric signals. At least parts of the audio module 280 may be included, for example, in the I/O interface 145 shown in FIG. 1. The audio module 280 may process sound information inputted or outputted through a speaker 282, a receiver 284, an earphone 286, or a microphone 288.

The camera module 291 is a device capable of acquiring still images and moving images. According to an embodiment, the camera module 291 may include at least one image sensor (e.g., a front sensor or a rear sensor), a lens, an image signal processor (ISP), or a flash (e.g., LED or xenon lamp).

The power management module 295 may manage electric power of the electronic device 201. Although not shown, the power management module 295 may include, for example, a power management integrated circuit (PMIC), a charger IC, or a battery or fuel gauge. The PMIC may have wired and/or wireless charging types. A wireless charging type may include, for example, a magnetic resonance type, a magnetic induction type, or an electromagnetic type. Any additional circuit for a wireless charging may be further used such as a coil loop, a resonance circuit, or a rectifier. The battery gauge may measure the residual amount of the battery 296 and a voltage, current or temperature in a charging process. The battery 296 may store or create electric power therein and supply electric power to the electronic device 201. The battery 296 may be, for example, a rechargeable battery or a solar battery.

The indicator 297 may show thereon a current status (e.g., a booting status, a message status, or a recharging status) of the electronic device 201 or of its part (e.g., the AP 210). The motor 298 may convert an electric signal into a mechanical vibration. Although not shown, the electronic device 201 may include a specific processor (e.g., GPU) for supporting a mobile TV. This processor may process media data that comply with standards of DMB (Digital Multimedia Broadcasting), DVB (Digital Image Broadcasting), or mediaFlo™.

Each of the above-discussed elements of the electronic device disclosed herein may be formed of one or more components, and its name may be varied according to the type of the electronic device. The electronic device disclosed herein may be formed of at least one of the above-discussed elements without some elements or with additional other elements. Some of the elements may be integrated into a single entity that still performs the same functions as those of such elements before integrated.

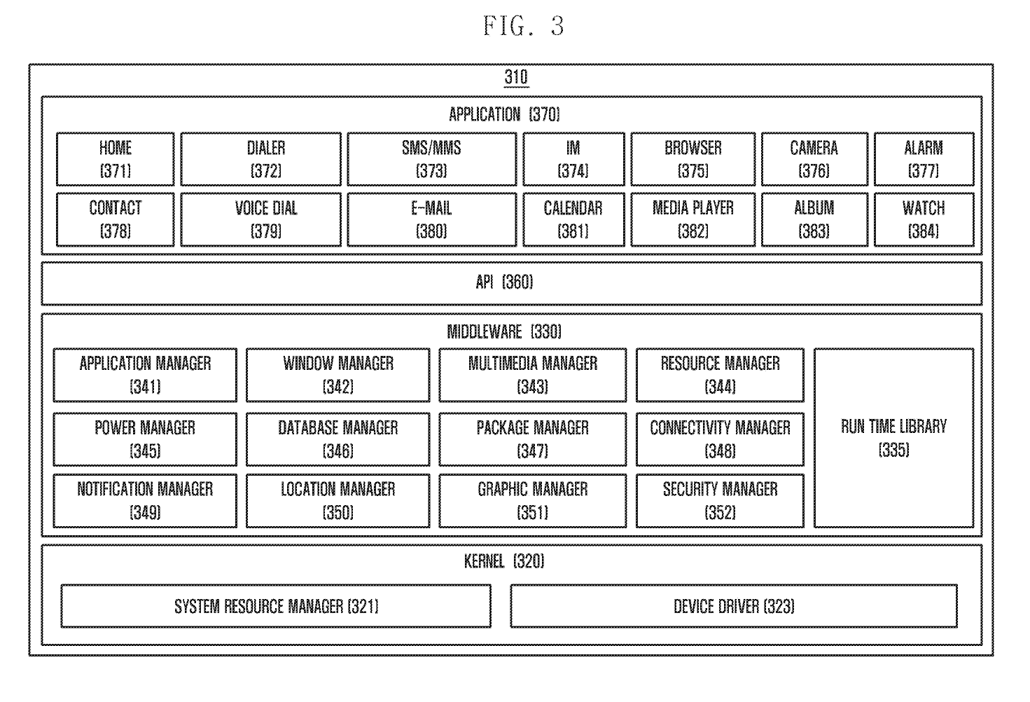

FIG. 3 is a block diagram illustrating a program module according to various embodiments. According to one embodiment, the program module 310 (e.g., the program 140) may include an OS controlling resources related to an electronic device (e.g., the electronic device 101) and/or various applications (e.g., the application program 147) executed in the OS. For example, the OS may be Android™, iOS™, Windows™, Symbian™, Tizen™, Bada™, and the like.

The program module 310 may include a kernel 320 (e.g., the kernel 141), a middleware 330 (e.g., the middleware 143), an API 360 (e.g., the API 145), and/or the application 370 (e.g., the application program 147). At least a part of the program module 310 may be preloaded in the electronic device or downloaded from an external electronic device (e.g., the electronic device 102, 104 or the server 106).

The kernel 320 may include a system resource manager 321 and/or a device driver 323. The system resource manager 321 may perform the control, allocation, recovery, and/or the like of system resources. According to one embodiment, the system resource manager 321 may include a process manager, a memory manager, or a file system manager. The device driver 323 may include, for example, a display driver, a camera driver, a Bluetooth driver, a shared memory driver, a USB driver, a keypad driver, a Wi-Fi driver, an audio driver, or an inter-process communication (IPC) driver.

The middleware 330 may include multiple modules previously implemented so as to provide a function used in common by the applications 370. Also, the middleware 330 may provide a function to the applications 370 through the API 360 in order to enable the applications 370 to efficiently use limited system resources within the electronic device. For example, as illustrated in FIG. 3, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager.

The runtime library 335 may include, for example, a library module used by a complier, in order to add a new function by using a programming language during the execution of the application 370. According to an embodiment of the present disclosure, the runtime library 335 may perform functions which are related to input and output, the management of a memory, an arithmetic function, and/or the like.

The application manager 341 may manage, for example, a life cycle of at least one of the applications 370. The window manager 342 may manage GUI resources used on the screen. For example, when at least two displays 260 are connected, the screen may be differently configured or managed in response to the ratio of the screen or the action of the application 370. The multimedia manager 343 may detect a format used to reproduce various media files and may encode or decode a media file through a codec appropriate for the relevant format. The resource manager 344 may manage resources, such as a source code, a memory, a storage space, and/or the like of at least one of the applications 370.

The power manager 345 may operate together with a basic input/output system (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity manager 348 may manage a wireless connectivity such as, for example, Wi-Fi and Bluetooth. The notification manager 349 may display or report, to the user, an event such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like. According to an embodiment, when the electronic device (e.g., the electronic device 101) has a telephone function, the middleware 330 may further include a telephony manager for managing a voice telephony call function and/or a image telephony call function of the electronic device.

The middleware 330 may include a middleware module for forming various functional combinations of the above-described elements. The middleware 330 may provide modules specialized according to types of OS s in order to provide differentiated functions. Also, the middleware 330 may dynamically delete some of the existing elements, or may add new elements.

The API 360 (e.g., the API 145) is a set of API programming functions, and may be provided with a different configuration according to an OS. In the case of Android or iOS, for example, one API set may be provided to each platform. In the case of Tizen, for example, two or more API sets may be provided to each platform.

The applications 370 (e.g., the applications 147) may include, for example, a home application 371, a dialer application 372, a Short Message Service (SMS)/Multimedia Message Service (MMS) application 373, an Instant Message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, or at least one application capable of performing functions such as health care (e.g., measurement of exercise amount or blood glucose) or environmental information provision (e.g., providing information about air pressure, humidity, temperature, or the like).

According to various embodiments, an application may include a payment application (e.g., Samsung Pay™ Application). The payment application may provide, for example, a user interface (UI) (or user experience (UX)) related to payment. For example, the payment application may provide a user interface related to card registration, payment, or transaction. The payment application may provide an interface related to card registration through, for example, a character reader (e.g., optical character reader/recognition (OCR)) or an external input. Further, the payment application may provide an interface related to user authentication through, for example, identification and verification (ID&V).

According to various embodiments, the payment application may perform payment transaction using the payment application. For example, the payment application may provide a payment function to a user through execution of simple pay, quick pay, or designated applications. The user may perform the payment function using the payment application, and may be provided with information related to the payment function.

For example, the notification relay application may have a function of sending notification information generated in other applications (e.g., the SMS/MMS application, the email application, the healthcare application, or the environmental information application) of the electronic device to the external electronic device. Further, the notification relay application may receive notification information from the external electronic device and provide it to the user.

The device management application may manage (e.g., install, delete, or update) at least one function (e.g., turn-on/turn-off of the external electronic device itself or some components thereof or adjusting the brightness or resolution of the display) of the external electronic device, at least one application running in the external electronic device, or at least one service (e.g., a call service or a message service) provided in the external electronic device.

According to an embodiment, the applications 370 may include an application (e.g., a healthcare application of a mobile medical device, etc.) designated depending on the attributes of the external electronic device. According to one embodiment, the applications 370 may include an application received from the external electronic device. According to one embodiment, the applications 370 may include a preloaded application or a third party application downloadable from a server. The names of elements of the program module 310 according to the illustrated embodiment may be varied depending on the type of the operating system.

According to various embodiments, at least a part of the program module 310 may be implemented in software, firmware, hardware, or a combination thereof At least a part of the program module 310 may be implemented (e.g., executed) by, for example, a processor (e.g., 210). At least a part of the program module 310 may include, for example, modules, programs, routines, sets of instructions, or processes to perform one or more functions.

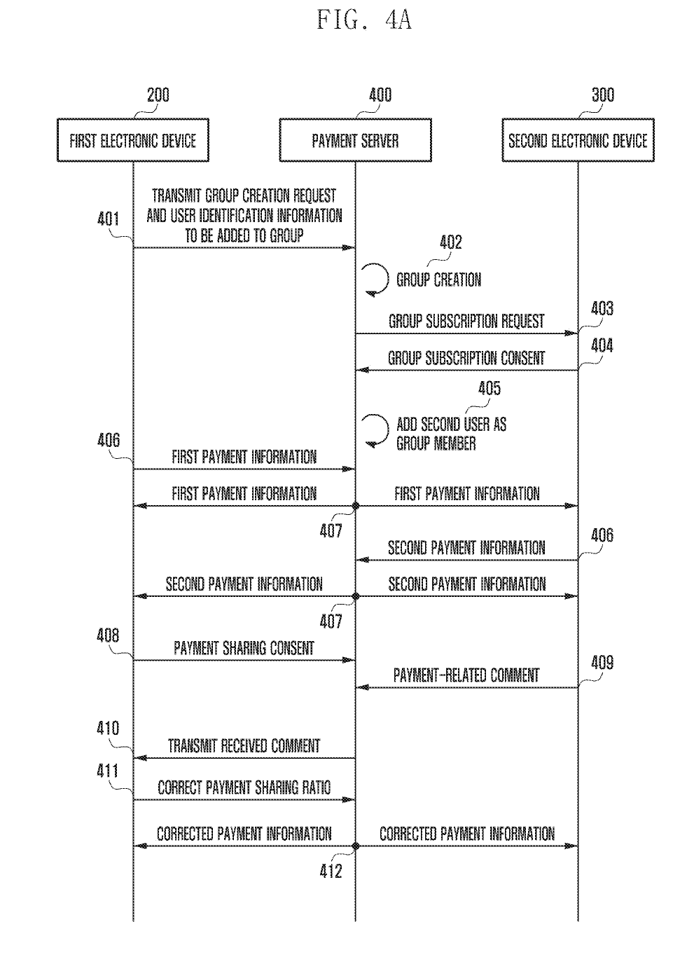

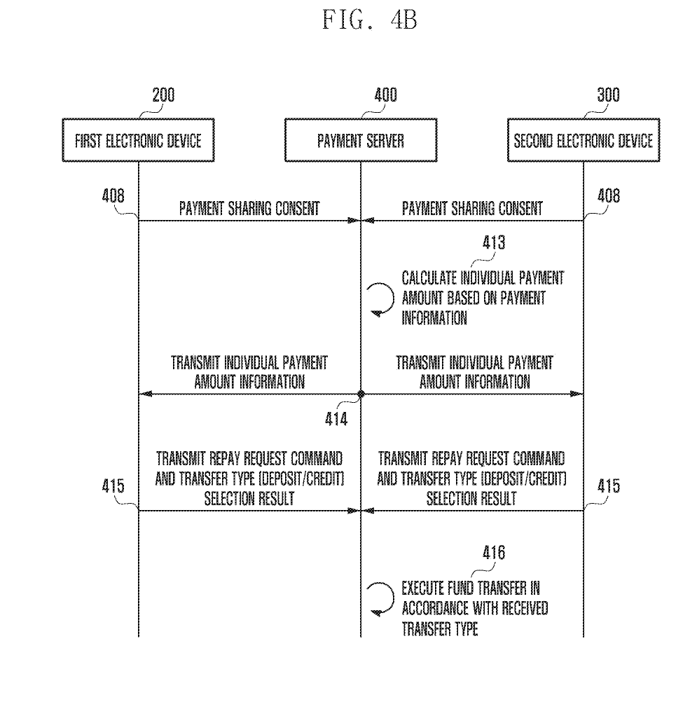

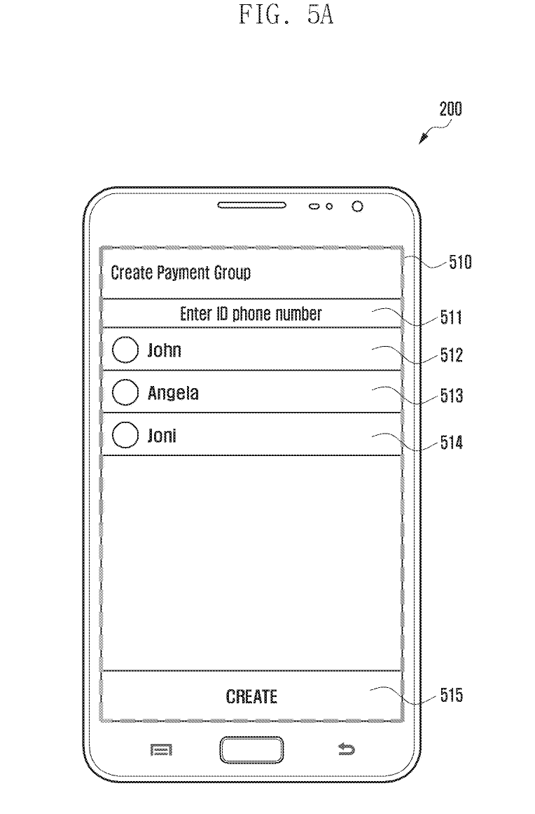

FIGS. 4A and 4B are flowcharts illustrating a payment sharing method between group users according to various embodiments of the disclosure.

According to various embodiments, a plurality of users may purchase articles or services in accordance with a common purpose of a group, and may bear purchase amounts in common. For example, the plurality of users may share payments with one another.

According to various embodiments of the disclosure, a user may create a group including at least one other user to share the payments with each other, and may share the payments for the purchase performed by at least one user of the group.

With reference to FIGS. 4A and 4B, at operation 401, a first user using a payment service according to various embodiments may transmit a creation request for a group to share payments to a payment server 400 through a first electronic device 200 corresponding to the first user.

According to various embodiments, if the group creation request is received from the first electronic device 200, the payment server 400 may create a group including the first user as a member.

For example, the payment server 400 may create a group, collect purchase histories of members of the group, and provide a private channel for automatically synchronizing the purchase histories whenever purchase through a payment service is performed.

At operation 401, according to various embodiments, the first electronic device 200 may transmit identification information of another user to be added to the group to the payment server 400.

For example, the first user may transmit user identification information (e.g., phone number or payment service ID) corresponding to another user (e.g., second user) to be added as a member of the group to the payment server 400 through a payment application of the first electronic device 200.

According to various embodiments, at operation 402, the payment server 400 may create a group including the first user based on the group creation request received from the first electronic device 200.

According to various embodiments, at operation 403, the payment server 400 may transmit a group subscription request to an electronic device (e.g., second electronic device 300) of the user corresponding to the user identification information based on the user identification information received from the first electronic device 200.

For example, the payment server 400 is a payment application installed in the second electronic device 300 corresponding to the second user intended to be added as a group member, and it may transmit a push message for the group subscription request.

According to an embodiment, if it is determined that the second user intended to be added as a group member does not subscribe to the payment service, the payment server 400 may request the second electronic device 300 corresponding to the user to subscribe to the payment service using SMS or other text message services.

For example, the second user requested to subscribe to the payment service may subscribe to the group after subscribing to the payment service.

According to another embodiment, the first user may directly transmit the group subscription request to the second electronic device 300 of the second user intended to invite to the group through an NFC tag method using the first electronic device 200.

According to various embodiments, if the user requested to subscribe to the group consents to the group subscription at operation 404, the payment server 400 may confirm the corresponding user as a member of the group.

At operation 406, according to various embodiments, the payment server may receive payment information about purchases of the respective users in the group from the electronic devices 200 and 300 corresponding to the respective users.

For example, at operation 406, the payment server 400 may receive, from the electronic devices 200 and 300 corresponding to at least one user in the group, payment information about the purchases pre-paid by the users before the users subscribe to the group.

For example, the payment information may include at least one of a payment amount, payment item, purchaser's name, purchasing place, merchant's name or firm name, purchasing location, or individual payment sharing ratio.

According to another embodiment, the payment server 400 may receive payment information of planned purchase items from the electronic devices 200 and 300 corresponding to at least one user in the group.

For example, a user of the group may transmit payment information of planned purchase items, which have not yet been purchased, but of which the payment is intended to be shared, to the payment server 400 through the electronic devices 200 and 300.

At operation 407, according to various embodiments, the payment server 400 may transmit the payment information received from at least one of the electronic devices 200 and 300 to all the electronic devices 200 and 300 corresponding to respective members of the group.

Although not illustrated, the payment server 400 may individually transmit respective pieces of payment information (e.g., first payment information and second payment information) received from at least one of the electronic devices 200 and 300 to all the electronic devices 200 and 300 of the group, or it may transmit integrated payment information in which the respective pieces of payment information are integrated.

At operations 408 and 409, according to various embodiments, the payment server 400 may receive a payment sharing consent response and/or a payment comment from at least one of the electronic devices 200 and 300 corresponding to the respective users of the group.

For example, the payment server 400 may receive the payment sharing consent response of the first user from the first electronic device 200. For example, among the received payment information, the first user may transmit a partial payment sharing consent response or the whole payment sharing consent response through the first electronic device 200.

According to various embodiments, respective users of the group may transmit comments on the payment information to the payment server 400.

For example, the second user may transmit a comment on the first payment information or the second payment information through the second electronic device 300.

For example, the payment server 400 may transmit the payment comment received from the second electronic device 300 to the electronic device 200 corresponding to another user of the group.

For example, the first user may receive the comment of the second user through the first electronic device 200, and may transmit a request for correction of the payment sharing ratio by payment items to the payment server 400 based on the comment of the second user.

For example, at operation 412, the payment server 400 may transmit corrected payment information to the first electronic device 200 and the second electronic device 300 based on the payment sharing ratio correction request received from the first user.

For example, the respective users of the group may transmit responses for consenting to the payment sharing based on the corrected payment information to the payment server 400 through the electronic devices 200 and 300.

According to various embodiments, the consent to the payment sharing may be performed after completion of the purchase and payment, or may be pre-performed before the purchase is performed.

At operation 413, according to various embodiments, if the payment sharing consent responses are received from all the electronic devices 200 and 300 corresponding to the respective users of the group, the payment server 400 may calculate individual payment amounts allocated to the respective users of the group at least based on the payment information and the payment sharing consent responses.

At operation 414, the payment server 400 according to various embodiments may transmit the calculated individual payment amount information to the electronic devices 200 and 300 corresponding to the respective users of the group.

At operation 415, according to various embodiments, respective users of the group may identify the received individual payment amount information, and may request the payment server 400 to perform repay (transfer) between the group users based on the individual payment amounts.

For example, based on the calculated individual payment amounts, the payment server 400 may withdraw money from a payment service account of at least one user in the group and it may deposit the money into a payment service account of another user.

Here, the payment service accounts may mean virtual accounts that are provided and managed by the payment server 400 as respective users subscribe to the payment service.

At operation 415, according to various embodiments, the payment server 400 may receive transfer type selection responses of deposit transfer and/or credit transfer from at least one of user electronic devices 200 and 300 corresponding to the payment service account from which money is to be withdrawn.

For example, the transfer type may be at least one of the deposit transfer from the deposit balance and the credit transfer from the credit balance in accordance with the balance type of the payment service account.

For example, a user may select the transfer type so that payment of some amount of money is performed through the deposit transfer, and payment of the remaining amount of money is performed through the credit transfer.

At operation 416, the payment server 400 may withdraw the money from the payment service account of at least one user, and it may deposit the money into the payment service account of another user in accordance with the result of the transfer type selection.

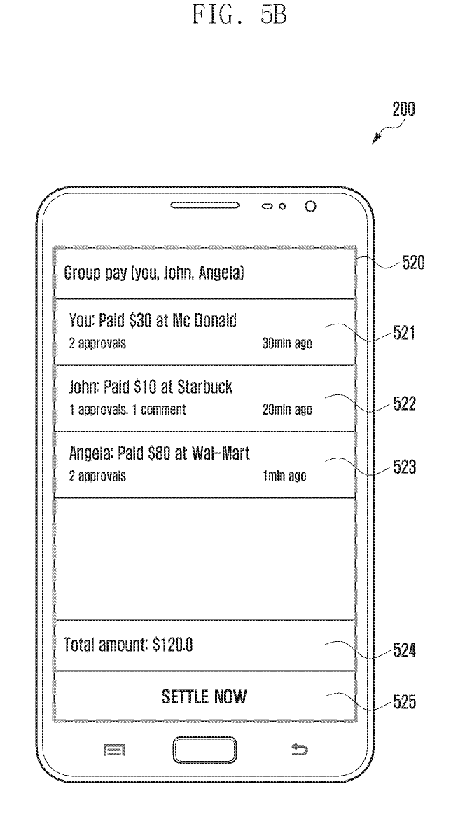

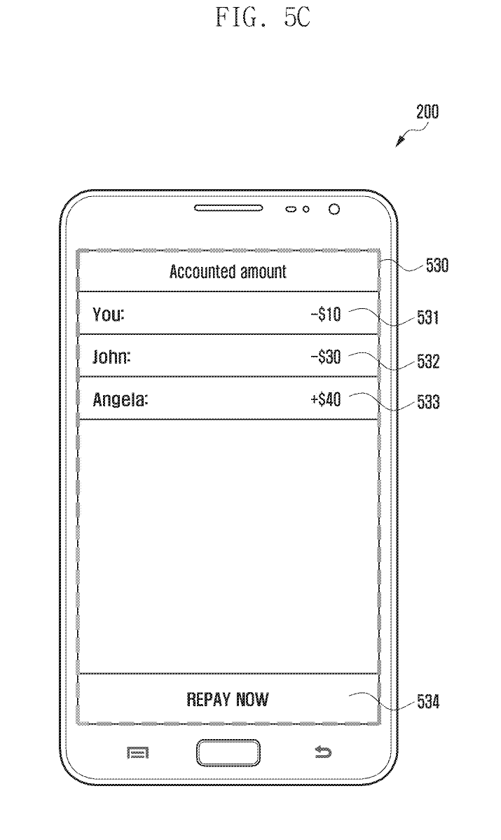

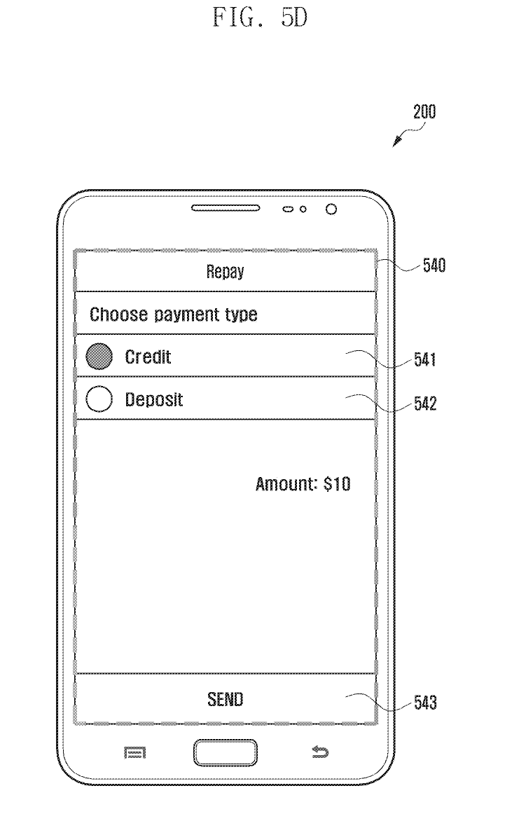

FIGS. 5A to 5D are diagrams illustrating a user interface for a payment sharing method through an electronic device 200 according to various embodiments of the disclosure.

According to various embodiments, a user may create a sharing group to share payment using a payment application installed in the electronic device 200, and the user may select a member of the group.

With reference to FIG. 5A, the electronic device 200 according to various embodiments may display a group creation screen 510 through the payment application.

For example, the group creation screen 510 of the electronic device 200 may include a group member search item (“Enter ID or phone number”) 511, a list of group members 512, 513, and 514, and a group creation item (“CREATE”) 515.

For example, the user may search for a user intended to be added by inputting user identification information (e.g., phone number or payment service ID) corresponding to the user intended to be added as a group member in the group member search item 511 of the group creation screen 510.

According to an embodiment, the list of group members 512, 513, and 514 may mean a list of group members added by the user.

For example, if the user searches for and selects a user intended to be added to the group through the group member search item 511, the electronic device 200 may display identification information (e.g., “John”, “Angela”, and “Joni”) corresponding to the selected user on the list of group members 512, 513, and 514.

According to various embodiments, the user may confirm the group creation request through an input (e.g., touch input) of the group creation item (“CREATE”) 515 of the group member creation screen 510 after selecting all users intended to be added to the group.

According to various embodiments, the payment server 400 may receive user's group creation request from the electronic device 200, and it may transmit a group subscription request to the payment application of the electronic device 200 corresponding to the user in the list of group members 512, 513, and 514.

For example, if the user in the list of group members does not subscribe to the payment service or if the payment application is not installed, the payment server 400 may request the payment service subscription and/or payment application installation using SMS or other text message services.

With reference to FIG. 5B, the electronic device 200 according to various embodiments may display a payment list screen 520 for purchase performed by respective users in the group.

For example, the payment list screen 520 may include purchase items 521, 522, and 523, a total payment amount display item 524, and a settlement item (“SETTLE NOW”) 525.

According to various embodiments, each of the purchase items 521, 522, and 523 displayed on the payment list screen 520 may include payment information, such as purchaser related to the purchase, merchant's name or firm name, purchase date, and payment amount.

According to various embodiments, each user in the group may select one of the purchase items 521, 522, and 523, and the user may input a sharing opinion related to each purchase item.

Although not illustrated, according to various embodiments, the user may differently input the individual sharing ratio between group members for the purchase items 521, 522, and 523 through the payment application of the electronic device 200.

According to various embodiments, each user in the group may determine whether to share the payment with reference to the payment information including the individual sharing ratio and sharing opinions of the respective users by purchase items 521, 522, and 523.

According to various embodiments, the electronic device 200 may display the total payment amount (e.g., $120.0) of the respective purchase items 521, 522, and 523 on the total payment amount display item 524 of the payment list screen 520.

For example, the total payment amount may be an amount of money obtained by adding up the payment amounts of all the purchase items 521, 522, and 523 displayed on the payment list screen 520, or it may be an amount of money obtained by adding up only the payment amounts of the purchase items to which the payment sharing consent is received by all the members of the group.

According to various embodiments, the user may get to the next stage for the payment sharing through an input (e.g., touch input) onto a settlement item (“SETTLE NOW”) 525 displayed on the payment list screen 520 of the electronic device 200.

With reference to FIG. 5C, the electronic device according to various embodiments may receive the individual payment amount information allocated to respective users in the group from the payment server, and it may display the individual payment amount information on an individual payment amount display screen (“Accounted amount”) 530.

The payment server may calculate the individual payment amount information allocated to the respective users of the group at least based on the payment information including whether to consent to payment sharing by purchase items and a payment amount, a payer, and an individual sharing ratio, and it may provide the individual payment amount information to the respective users of the group.

For example, as illustrated in FIG. 5C, for payment sharing, the electronic device 200 may simply display, on the individual payment amount display screen 530, information that $10 may be withdrawn from the first user indicated as “You” (531), $30 may be withdrawn from the second user indicated as “John” (532), and $40 may be deposited into the third user indicated as “Angela” (533).

According to various embodiments, the user may get to the next stage for the payment sharing through an input (e.g., touch input) onto a repay item (“REPAY NOW”) 534 displayed on the individual payment amount display screen 530.

With reference to FIG. 5D, the electronic device 200 may display a fund transfer type selection screen 540 for repay through a payment application.

According to various embodiments, as illustrated in FIG. 5D, the user may select one transfer type between deposit transfer and credit transfer. Although not illustrated, the user may select the transfer types in a manner that the user repays at least a part of an amount of money through deposit transfer and the user repays the remaining amount of money through credit transfer.

According to various embodiments, if an input is received onto a send item (“SEND”) 543 of the electronic device 200, the payment server 400 may transfer the money of the payment service account in accordance with the transfer type selected between the deposit transfer 542 and the credit transfer 541.

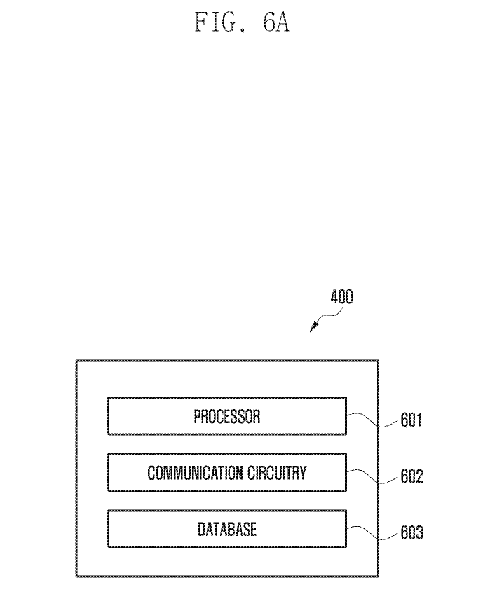

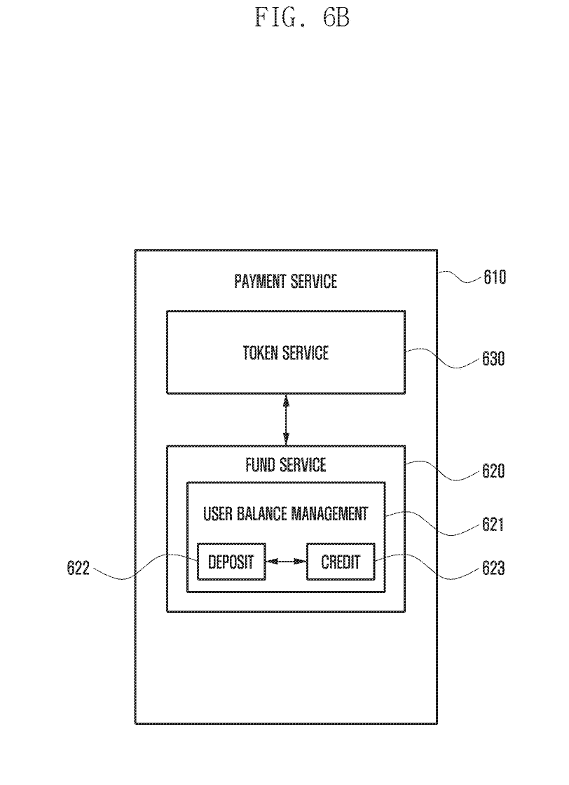

FIG. 6A is a block diagram illustrating the configuration of a payment server 400 according to various embodiments of the disclosure.

According to various embodiments, as illustrated in FIG. 6A, the payment server 400 may include a processor 601, a communication circuitry 602, and a database 603.

According to various embodiments, the communication circuitry 602 may communicate with a plurality of electronic devices 200 and 300. For example, the communication circuitry 602 may receive, from the first electronic device 200 and/or the second electronic device 300, a group creation request, identification information of a user to be added as a member of a group, and payment information about payment performed by the group member. For example, the communication circuitry 602 may transmit the payment information, the calculated individual payment information, and the result of fund transfer to the first electronic device 200 and/or the second electronic device 300.

According to various embodiments, the database 603 may store various pieces of group information received in the payment server 400.

For example, the database 603 may store therein user identification information of users having subscribed to a payment service, payment service account information of respective users, user items corresponding to members of the created group, and payment information received from the users of the group.

According to various embodiments, the processor 601 may generally control the communication circuitry 602 and the database 603.

For example, the processor 601 may control the communication circuitry 602 to transmit and receive information with the electronic device.

For example, the processor 601 may classify information (e.g., payment information and user identification information) received through the communication circuitry 602 in accordance with a specific basis to store the classified information in the database 603.

For example, the processor 601 may calculate individual payment amounts allocated to respective users of the group at least based on the payment information received through the communication circuitry 602 and payment consent responses.

For example, the processor 601 may transfer money from at least one payment service account of the group to a payment service account of another user based on the calculated individual payment amount and the transfer type received from the electronic device of the user corresponding to the payment service account from which the money is withdrawn.

FIG. 6B is a block diagram schematically illustrating the configuration of a payment service 610 supported through a payment server 400 according to various embodiments of the disclosure.

According to various embodiments, the payment service 610 may include a token service 630 and a fund service 620.

According to various embodiments, the token service 630 may issue payment-related information (e.g., token), or it may provide a management function, such as token authentication for deletion, activation, or payment. For example, the token may be an identifier (ID) capable of identifying a card obtained from a card company when the card is registered in the electronic device. The token may include at least a number capable of identifying the card company. For example, the user may perform payment through the electronic device 200 using the token service 630.

According to various embodiments, the payment server 400 may create and manage a virtual payment service account in accordance with user's subscription to the payment service 610.

According to various embodiments, the fund service 620 may provide a function of managing a balance 621 of the payment service account.

According to various embodiments, the balance 621 of the user's payment service account managed through the fund service 620 may include a deposit balance (“deposit”) 622 and a credit balance (“credit”) 623.

The deposit balance 622 may be, for example, in association with a deposit service of a bank, and it may include an amount of money transferred from the deposit account or an amount of money transferred from a payment service account of another user.

The credit balance 623 may be, for example, in association with a card service of a credit card company, and it may include an amount of money configured to be deducted from a predetermined user's credit limit or an amount of money credit-transferred from the payment service account of another user.

According to various embodiments, the fund service 620 may provide a function of transferring money from the balance of the user's payment service account to the balance of the payment service account of another user.

For example, the users of the group intended to share the payment can share the payment by performing the fund transfer from the balances of the users' payment service accounts after performing their payments. Accordingly, it is not necessary for a plurality of users to perform payments together, and the payment can be shared even in the case of purchasing from a plurality of merchants

According to another embodiment, the fund service 620 may provide a function of performing the payment (online or offline) using the balance of the user's payment service account.

For example, if the user requests to perform the payment using the payment service 610 through the payment application of the electronic device 200 on offline, the electronic device 200 may transfer user's payment service primary account number (PAN) to a point of sales (PoS) of the merchant. Here, the payment service PAN may mean a virtual PAN issued by the payment server 400 in accordance with the user's payment service subscription. For example, the payment service PAN is in association with the credit balance of the user's payment service account, and the payment server 400 can withdraw the payment amount from the payment service account in accordance with the authentication result of the payment service PAN.

According to various embodiments, if the payment approval using the payment service 610 is completed through a specific authentication procedure, a payment company providing the payment service 610 may impose a specific payment fee on the merchant

For example, the payment fee may be similar to a merchant fee that a card company imposes on a merchant in accordance with payment by a credit card (or debit card). For example, if a user performs payment using the payment service 610, a payment company providing the payment service 610 may pay an amount of money obtained by taking first the payment fee in a predetermined ratio from the total payment amount to the merchant after a specific time limit instead of the user.

According to various embodiments, because the payment company providing the payment service 610 can make a profit through the payment fee, it may provide benefits, such as point grant or discount service, when the user performs the payment using the payment service in order to guide the payment using the user's payment service 610.

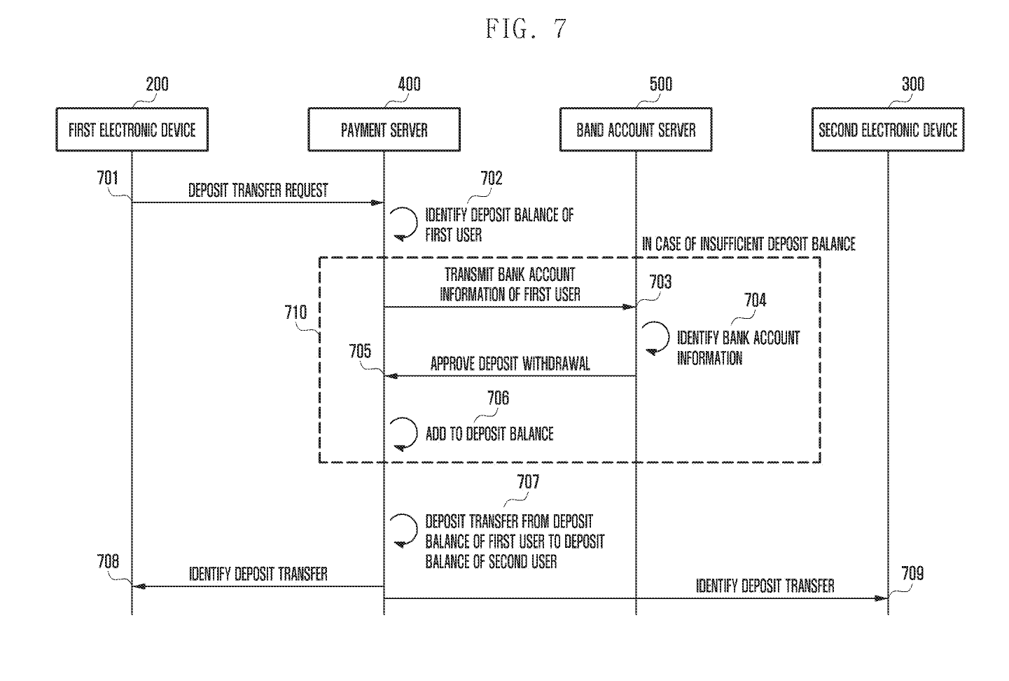

FIG. 7 is a diagram illustrating a deposit transfer operation between users, which is provided through a payment service 610 according to various embodiments of the disclosure.

According to various embodiments, a user may transfer money from a deposit balance of user's payment service account to a deposit balance of a payment service account of another user using the payment service 610.

According to various embodiments, a payment system for deposit transfer may include a first electronic device 200, a second electronic device 300, a payment server 400, and a band account server 500.

At operation 701, according to various embodiments, a first user may transmit a deposit transfer request to the payment server 400 through a payment application installed in the first electronic device 200.

For example, the first user may transmit, to the payment server 400 through the first electronic device 200, a transfer request for withdrawing money from a payment service account of the first user and depositing the money into a payment service account of a second user.

At operation 702, according to various embodiments, the payment server 400 may identify the deposit balance of the payment service account of the first user.

For example, the payment server 400 may identify whether the deposit balance is insufficient by comparing the deposit transfer amount requested by the first user with the deposit balance of the first user.

According to various embodiments, if the deposit balance of the payment service account is smaller than the requested deposit transfer amount, the payment server 400 may supplement the deposit balance of the payment service account through a series of operations 710 including operations 703 to 706.

According to various embodiments, if it is identified that the deposit balance of the first user is insufficient (710) at operation 702, the payment server 400, at operation 703, may transmit authentication information including bank account information of the first user to the bank account server 500.

According to various embodiments, at operation 704, the bank account server 500 may perform a specific authentication procedure by identifying the received information.

For example, at operation 705, the bank account server 500 may approve withdrawal of money to the payment service account in accordance with the authentication result identified through the bank account information. For example, at operation 705, the bank account server 500 may transmit the result of withdrawal approval to the payment server 400. The bank account server 500 may transfer the money from the predetermined bank account of the first user to the payment service account of the first user in accordance with the withdrawal approval.

For example, at operation 706, the payment server 400 may supplement the deposit balance of the payment service account of the first user in accordance with a withdrawal approval notification received from the bank account server 500.

According to various embodiments, at operation 707, the payment server 400 may transfer the money from the payment service account of the first user to the payment service account of the second user.

According to various embodiments, at operations 707 and 708, the payment server 400 may transmit the transfer result to the payment applications installed in the first electronic device 200 corresponding to the first user and the second electronic device 300 corresponding to the second user.

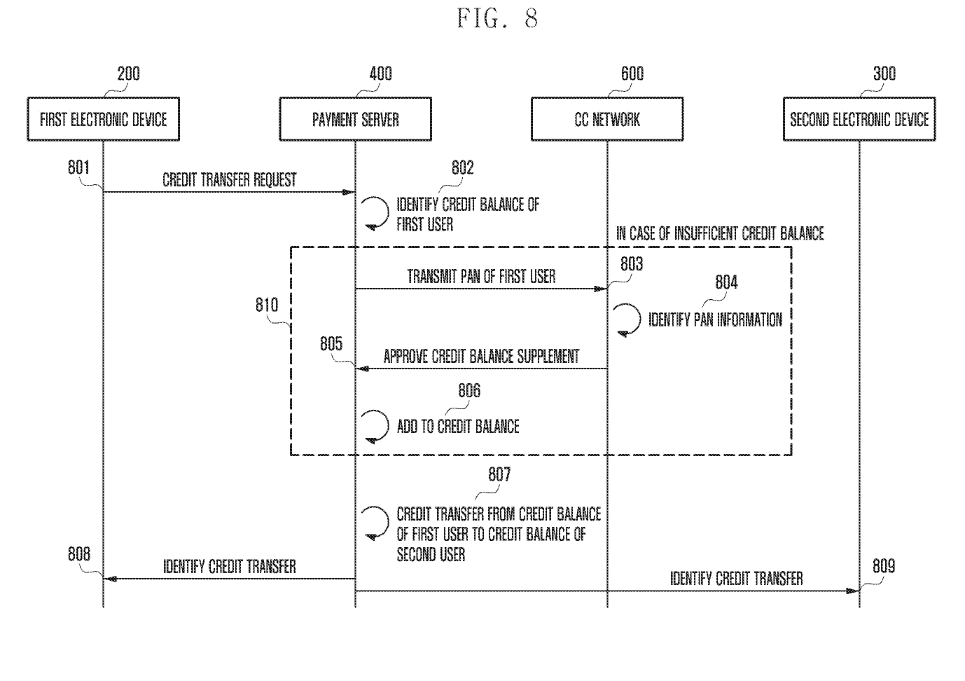

FIG. 8 is a diagram illustrating a transferring credit operation between users in a payment system according to various embodiments of the disclosure.

According to various embodiments, a user using a payment service may request credit transfer for payment sharing through payment applications installed in electronic devices 200 and 300.

According to various embodiments, a payment system may include a first electronic device 200, a second electronic device 300, a payment server 400, and a credit card network (CC network) 600.

At operation 801, according to various embodiments, a first user may transmit a credit transfer request to the payment server 400 through a payment application installed in the first electronic device 200.

For example, the first user may transmit, to the payment server 400 through the first electronic device 200, a request for supplementing the credit balance of the payment service account of the second user by deducting the credit limit from the credit balance of the payment service account of the first user.

At operation 802, according to various embodiments, the payment server 400 may identify the credit balance of the payment service account of the first user. For example, the payment server 400 may identify whether the credit balance is insufficient by comparing the credit transfer amount requested by the first user with the credit balance of the first user.

According to various embodiments, if the credit balance of the payment service account is smaller than the requested credit transfer amount, the payment server 400 may supplement the credit balance of the payment service account through a series of operations 810 including operations 803 to 806.

Here, the credit balance supplement of the payment service account may mean that the user performs the purchase corresponding to the amount of money to be supplemented from the payment server 400 through a credit card connected to the CC network 600. For example, the amount of money to supplement the credit balance may correspond to the purchase amount that is paid through the credit card, and the payment server 400 may correspond to a merchant in the credit card transaction. For example, if the user requests to supplement the credit balance, the CC network 600 may pay, to the payment server 400, an amount of money obtained by taking first the payment fee in a predetermined ratio from the total payment amount after a specific time limit instead of the user. The payment server 400 may supplement the credit balance of the payment service account of the user with an amount of money corresponding to the payment amount.

According to various embodiments, if it is identified that the credit balance of the first user is insufficient at operation 802, the payment server 400, at operation 803, may transmit authentication information including primary account number (PAN) information of the credit card to the CC network 600 of the credit card predetermined by the first user.

According to various embodiments, at operation 804, the CC network 600 may perform a specific authentication procedure by identifying the received information.

For example, at operation 805, the CC network 600 may approve the credit withdrawal to the payment service account in accordance with the authentication result identified through the PAN information.

For example, at operation 805, the CC network 600 may transmit the approval result of the credit withdrawal to the payment server 400.

If the credit withdrawal is approved, the CC network 600 may deduct the use limit from the predetermined credit card of the first user, and may transfer the credit to the payment service account of the first user.

For example, at operation 806, the payment server 400 may supplement the credit balance of the payment service account of the first user in accordance with a credit withdrawal approval notification received from the CC network 600.

According to various embodiments, at operation 807, the payment server 400 may perform the credit transfer from the credit balance of the payment service account of the first user to the credit balance of the payment service account of the second user.

According to various embodiments, at operations 807 and 808, the payment server 400 may transmit the credit transfer result to the payment applications installed in the first electronic device 200 corresponding to the first user and the second electronic device 300 corresponding to the second user.

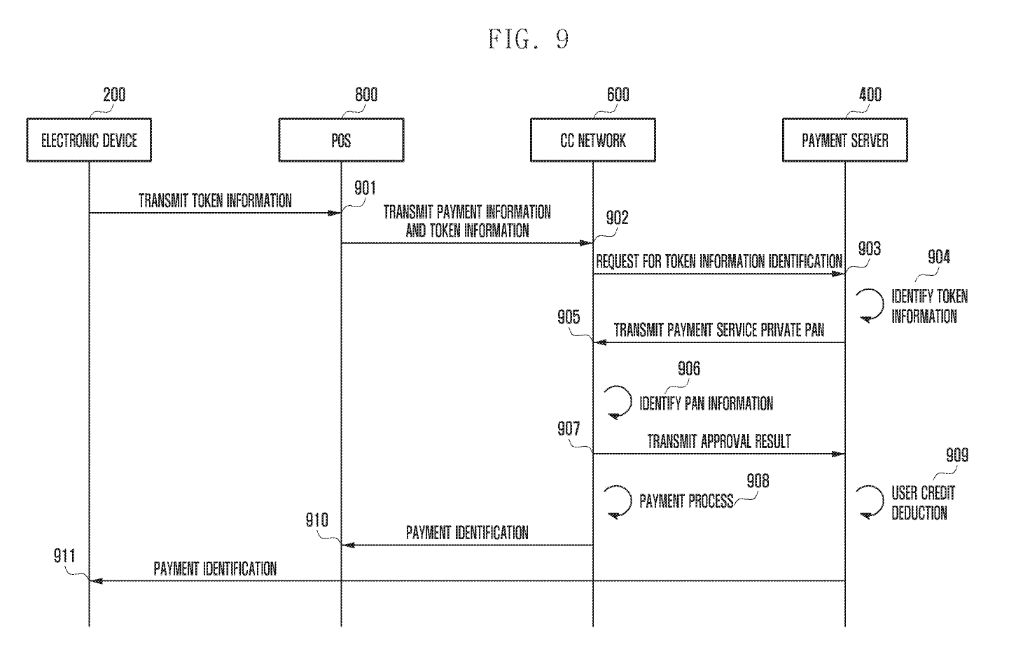

FIG. 9 is a diagram illustrating an offline payment operation in a payment system according to various embodiments of the disclosure.

According to various embodiments, a user may purchase articles or services on offline through payment using a payment service.

The payment system according to various embodiments may include an electronic device 200, a payment server 400, a CC network 600, and a merchant point of sales (PoS) 800.

At operation 901, according to various embodiments, the electronic device 200 may transmit token information stored in a memory 230 of the electronic device 200 to the merchant PoS 800 in accordance with a payment request using the payment service of the user. The token information stored in the memory 230 may be, for example, information about a torque pre-issued and received from the payment server 400.

According to various embodiments, the electronic device 200 may use various communication connections when transmitting the token information to the PoS 800. Here, the communication connection may include, for example, NFC, magnetic secure transmission (MST), barcode, or QR code.

At operation 902, according to various embodiments, the PoS 800 may transmit the received token information and/or payment information including the payment amount to the CC network 600. For example, the PoS 800 may transfer the token information received from the electronic device 200 and/or the payment information (e.g., payment amount and payment details) acquired from the PoS 800. For example, the payment information may be acquired from the PoS 800, or may be received from an external device, and may include the details of the payment requested by the user or a pre-performed payment history using the payment system.

At operation 903, according to various embodiments, the CC network 600 may transmit the token information and/or payment information to the payment server 400, and may request an identification authentication of the token information.

At operation 904, according to various embodiments, the payment server 400 may identify the token information received from the CC network 600.

For example, the payment server 400 may identify user's payment service PAN using the information included in the token.

Here, the payment service PAN may mean a virtual PAN issued by the payment server 400 in accordance with the user's payment service subscription. For example, the payment service PAN may be in association with the credit balance of the user's payment service account. For example, the payment server 400 may withdraw the payment amount from the user's payment service account in accordance with the authentication result of the payment service PAN.

At operation 905, according to various embodiment, the payment server 400 may transmit the PAN (e.g., payment service PAN) identified at operation 904 to the CC network 600.

At operation 906, according to various embodiments, the CC network may determine a payment approval by identifying the received PAN. For example, the CC network 600 may identify the PAN, and if the PAN coincides with information included in the CC network 600 (e.g., effective PAN), the CC network 600 may perform payment approval. For example, the CC network 600 may identify the PAN, and if the PAN does not coincide with information included in the CC network 600 (e.g., ineffective PAN), the CC network 600 may perform payment reject.

At operation 907, according to various embodiments, the CC network 600 may transmit the result of the payment approval to the payment server 400.

At operations 908 and 909, according to various embodiments, if the payment is approved, the CC network 600 may perform payment process for the merchant, and the payment server 400 may deduct the credit corresponding to the payment amount from the credit balance of the payment service account of the user.

At operation 910, according to various embodiments, the CC network 600 may transmit the result of the payment identification to the merchant PoS 800.

At operation 911, according to various embodiments, the payment server 400 may transmit the result of the payment identification to the electronic device 200. For example, the electronic device 200 may display the transmitted result of the payment identification using the payment application installed in the electronic device 200.

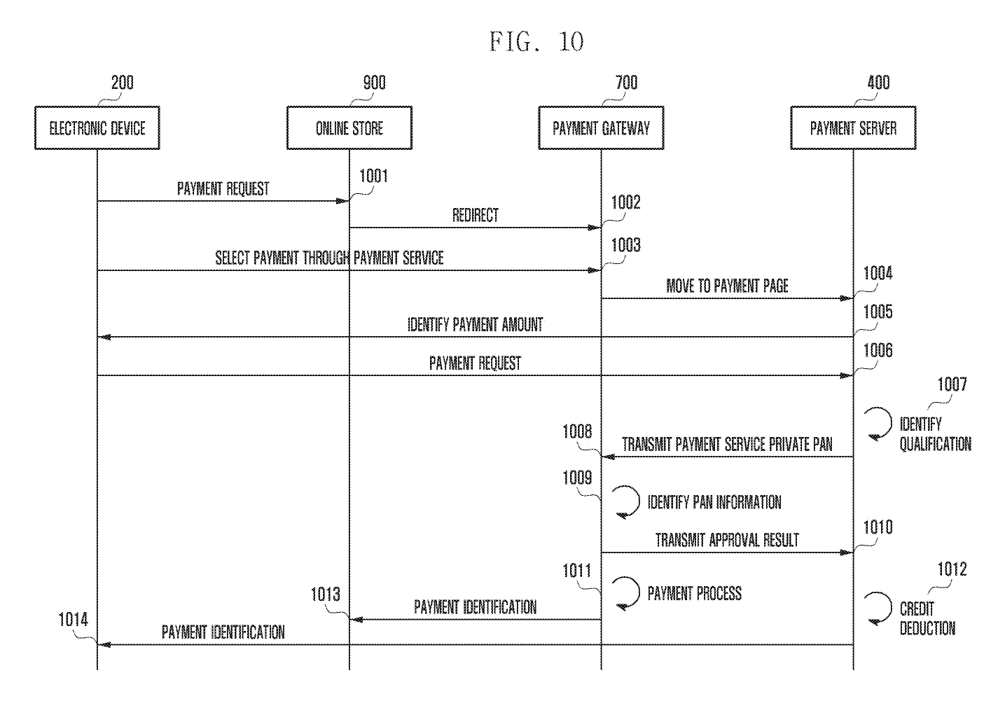

FIG. 10 is a diagram illustrating an online payment method in a payment system according to various embodiments of the disclosure.

According to various embodiments, a user may purchase articles or services on online through payment using a payment service.

The payment system according to various embodiments may include an electronic device 200, a payment server 400, a payment gateway 700, and an online store 900.

At operation 1001, according to various embodiments, a user may purchase articles or services on online using the electronic device. The electronic device 200 may transmit a payment request to the online store 900 in accordance with the user's purchase request.

At operation 1002, according to various embodiments, if the payment request is received, the online store 900 may redirect the payment request to the payment gateway 700. For example, the electronic device 200 may display a payment screen provided from the payment gateway 700 in accordance with operation 1002.

At operation 1003, according to various embodiments, the electronic device 200 may transmit the payment request using the payment service to the payment gateway 700.

At operation 1004, according to various embodiments, the payment gateway 700 may navigate to a checkout page provided by the payment server 400 in accordance with the payment request using the payment service.

At operation 1005, according to various embodiments, the payment server 400 may display payment amount information to be paid on the checkout page.

At operation 1006, according to various embodiments, the electronic device 200 may transmit the result of the user's payment amount information identification to the payment server 400.

At operation 1007, according to various embodiments, if the user's payment amount information identification is received, the payment server 400 may identify the user's payment qualification information in accordance with a specific authentication procedure. For example, the payment server 400 may identify the user's payment service PAN using the payment qualification information. For example, the payment service PAN may mean a virtual PAN issued by the payment server 400. For example, the payment service PAN may be in association with the credit balance of the user's payment service account. For example, the payment server 400 may withdraw the payment amount from the user's payment service account in accordance with the authentication result of the payment service PAN.

At operation 1008, according to various embodiments, the payment server 400 may transmit the payment service PAN to the payment gateway 700.

At operation 1009, according to various embodiments, the payment gateway 700 may determine payment approval by identifying the received PAN. For example, the payment gateway 700 may identify the PAN, and if the PAN is identified as an effective PAN, the payment gateway 700 may perform the payment approval. For example, the payment gateway 700 may perform the payment reject if it is identified that the PAN is ineffective.

At operation 1010, according to various embodiments, the payment gateway 700 may transmit the result of the payment approval to the payment server 400.

At operations 1011 and 1012, according to various embodiments, if the payment is approved, the payment gateway 700 may perform the payment process for the merchant, and the payment server 400 may deduct the credit corresponding to the payment amount from the credit balance of the user's payment service account.

At operation 1013, according to various embodiments, the payment gateway 700 may transmit the result of the payment identification to the online store 900.

At operation 1014, according to various embodiments, the payment server 400 may transmit the result of the payment identification to the electronic device 200.

The term “module” used in this disclosure may mean a unit including, for example, one or a combination of hardware, software, and firmware. The term “module” may be interchangeably used with other terms, for example, such as unit, logic, logical block, component, or circuit. The “module” may be the minimum unit, or a part thereof, of an integrally constructed component. The “module” may be the minimum unit, or a part thereof, for performing one or more functions. The “module” may be implemented mechanically or electronically. For example, according to the present disclosure, the “module” may include at least one of an application-specific integrated circuit (ASIC) chip, field-programmable gate arrays (FPGAs), and a programmable-logic device, which are known or to be developed later and perform particular functions.

According to various embodiments, at least a part of the device (e.g., modules or functions thereof) or the method (e.g., operations) may be implemented as instructions stored in a non-transitory computer-readable storage medium (e.g., the memory 130) in a programming module form. When the instructions are executed by a processor (e.g., 120), the processor may perform a function corresponding to the instructions.

The non-transitory computer-readable recording medium may include magnetic media such as a hard disk, a floppy disk, and a magnetic tape, optical media such as a Compact Disc Read Only Memory (CD-ROM) and a Digital Versatile Disc (DVD), magneto-optical media such as a floptical disk, and hardware devices specially configured to store and perform a program instruction. In addition, the program instructions may include high class language codes, which can be executed in a computer by using an interpreter, as well as machine codes made by a compiler.

A module or programming module according to various embodiments may include or exclude at least one of the above-discussed components or further include any other component. The operations performed by the module, programming module, or any other component according to various embodiments may be executed sequentially, in parallel, repeatedly, or by a heuristic method. Additionally, some operations may be executed in different orders or omitted, or any other operation may be added.

While this disclosure contains many specific implementation details, these should not be construed as limitations on the scope of the invention or of what may be claimed, but rather as descriptions of features that may be specific to particular embodiments of particular invention.

1. An electronic device comprising:
a communication module configured to communicate with an external device;
a display configured to display a user interface thereon;
a memory configured to store at least one piece of payment information therein; and
a processor,
wherein the processor is configured to:
transmit, to the external device, at least one of a group creation request, a request for adding a member to a group, or payment information about payment performed by a user corresponding to the electronic device, using the communication module,
receive, from the external device, integrated payment information including at least one of payment information transmitted to the external device or payment information about payment performed by another user of the group, and individual payment amounts of the users of the group calculated by the external device, using the communication module,
receive a result of fund transfer performed by the external device based on the individual payment amounts, and
display the result of the fund transfer using the display.

2. The electronic device of claim 1, wherein the fund transfer comprises withdrawing a fund from a payment service account of the at least one user of the group and depositing the fund into a payment service account of the other user.

3. The electronic device of claim 1, wherein transmission of the request for adding the member to the group comprises transmission of user identification information corresponding to a user intended to be added as a member of the group.

4. The electronic device of claim 1, wherein the processor is configured to transmit, to the external device, whether to consent to the payment performed by the user corresponding to the electronic device or the other user of the group and/or a user opinion on the payment using the communication module if the integrated payment information and/or the opinion of the other user in the group on the integrated payment information are received from the external device.

5. The electronic device of claim 2, wherein the processor is configured to display a user interface for selecting whether the fund transfer is performed by a deposit transfer type or a credit transfer type using the display if the payment service account from which the fund is withdrawn is the payment service account of the user corresponding to the electronic device.

6. The electronic device of claim 5, further comprising an input device,
wherein if the selection of the transfer type is input to the input device, the processor is configured to transmit the selection result to the external device using the communication circuitry.

7. The electronic device of claim 1, wherein the payment information comprises at least one of a payment amount, a payment item, a payer, or an individual sharing ratio.

8. An electronic device for payment sharing processing, comprising:
a communication circuitry configured to communicate with a first electronic device or a second electronic device;
a database configured to store at least one piece of payment information therein; and
a processor,
wherein the processor is configured to:
receive, from the first electronic device, a group creation request and identification information of a user to be added to a group, using the communication circuitry,
transmit a subscription request for the group to the second electronic device corresponding to the user identification information,
determine a user corresponding to the second electronic device as a member of the group if a group subscription consent response is received from the second electronic device,
receive at least one piece of payment information from at least one of the first electronic device or the second electronic device, and transmit integrated payment information including the received payment information to the first electronic device and the second electronic device,
calculate individual payment amounts of the respective users of the group and transmit the calculated individual payment amounts to the first electronic device and the second electronic device at least based on the integrated payment information and payment consent responses if the payment consent responses are received from the first electronic device and the second electronic device, and
perform a fund transfer operation by withdrawing money from a payment service account of the at least one user of the group and depositing the money into a payment service account of the other user if transfer consent responses based on the individual payment amounts are received from the first electronic device and the second electronic device.

9. The electronic device of claim 8, wherein the fund transfer is configured in at least one transfer type of a deposit transfer type or a credit transfer type in accordance with a selection of the user corresponding to the payment service account from which the fund is withdrawn.

10. The electronic device of claim 9, wherein the processor is configured to:
identify a deposit balance of the payment service account from which the fund is to be withdrawn if the fund transfer is executed in the deposit transfer type, and
transmit authentication information including a command for requesting a bank account server corresponding to a bank predetermined by the user of the payment service account from which the fund is to be withdrawn to make a transfer to the deposit balance and account information of the bank, using the communication circuitry, if the identified deposit balance of the payment service account is smaller than an amount of money to be withdrawn in the deposit transfer type.

11. The electronic device of claim 9, wherein the processor is configured to:
identify a credit balance of the payment service account from which the fund is to be withdrawn if the fund transfer is executed in the credit transfer type, and
transmit authentication information including a command for requesting a credit card (CC) network corresponding to a credit card predetermined by the user of the payment service account from which the fund is to be withdrawn to make a transfer to the credit balance and primary account number (PAN) information of the credit card, using the communication circuitry, if the identified credit balance of the payment service account is smaller than an amount of money to be withdrawn in the credit transfer type.

12. A payment sharing method comprising:
creating a group in accordance with a group creation request transmitted from a first electronic device and determining a plurality of users including a first user corresponding to the first electronic device as members of the group;
receiving at least one piece of payment information about payment performed by at least one of the plurality of users of the group from an electronic device corresponding to the at least one of the plurality of users and transmitting integrated payment information including the received payment information to electronic devices corresponding to the respective users of the group;
calculating individual payment amounts of the users of the group at least based on the integrated payment information and payment consent responses if the payment consent responses to the integrated payment information are received from the electronic devices corresponding to the respective users of the group; and
performing a fund transfer operation to transfer money from at least one payment service account of the group to a payment service account of the other user based on the individual payment amounts.

13. The method of claim 12, wherein determining as the members of the group comprises:
receiving, from the first electronic device, user identification information corresponding to a user intended to be added as a member of the group; and
transmitting a group subscription request to the electronic device corresponding to the identification information based on the received user identification information.

14. The method of claim 12, wherein the fund transfer is configured in at least one transfer type of a deposit transfer type or a credit transfer type in accordance with a selection of the user corresponding to the payment service account from which the fund is withdrawn, and
the method comprises:
identifying a deposit balance of the payment service account from which the fund is to be withdrawn if the fund transfer is executed in the deposit transfer type, and
transmitting authentication information including a command for requesting a bank account server corresponding to a bank predetermined by the user of the payment service account from which the fund is to be withdrawn to make a transfer to the deposit balance and account information of the bank, using the communication circuitry, if the identified deposit balance of the payment service account is smaller than an amount of money to be withdrawn in the deposit transfer type.

15. The method of claim 12, wherein the fund transfer is configured in at least one transfer type of a deposit transfer type or a credit transfer type in accordance with a selection of the user corresponding to the payment service account from which the fund is withdrawn, and
the method further comprises:
identifying a credit balance of the payment service account from which the fund is to be withdrawn if the fund transfer is executed in the credit transfer type, and
transmitting authentication information including a command for requesting a credit card (CC) network corresponding to a credit card predetermined by the user of the payment service account from which the fund is to be withdrawn to make a transfer to the credit balance and primary account number (PAN) information of the credit card, using the communication circuitry, if the identified credit balance of the payment service account is smaller than an amount of money to be withdrawn in the credit transfer type.
